(19) United States
(12) Patent Application Publication
(10) Pub. No.: US 2016/0198250 A1
(43) Pub. Date: Jul. 7, 2016

(54) HEADPHONE DEVICE WITH CONTROLLING FUNCTION

(71) Applicant: Primax Electronics Ltd., Neihu (TW)

(72) Inventor: YUNG-TAI PAN, Neihu (TW)

(21) Appl. No.: 14/639,687

(22) Filed: Mar. 5, 2015

(30) Foreign Application Priority Data
Jan. 5, 2015 (TW) 104100054

(51) Int. Cl. H04R 1/10; G06F 3/01; G06F 3/16

(52) U.S. Cl. CPC H04R 1/1041; G06F 3/165; G06F 3/017; H04R 2201/103; H04R 2201/109

(57) ABSTRACT

A headphone device with a controlling function is provided. The headphone device includes a headphone body and a transmitter. The transmitter includes an optical finger navigation module. The optical finger navigation module is installed on the transmitter and exposed to an operating surface of the transmitter. When the optical finger navigation module is operated with the user's finger, an audio generator in communication with the transmitter is correspondingly controlled. Since the optical finger navigation module generates the signal by an optical technology, even if the user wears a glove on a hand, the optical finger navigation module can be normally operated by the user.

### FIELD OF THE INVENTION

The present invention relates to a headphone device, and more particularly to a headphone device with a controlling function.

### BACKGROUND OF THE INVENTION

Generally, a headphone device is worn on the user's ears. The headphone device is in communication with an audio generator. The audio generator can play music and transmit an audio signal of the music to the headphone device. Consequently, the audio signal is outputted from the speakers of the headphone device so as to be listened by the user.

The headphone devices are usually classified into two types, i.e. an in-ear type headphone device and a circumaural type headphone device. For wearing the in-ear type headphone device, a headphone body of the headphone is inserted into the ear canal of the user. The in-ear type headphone device is small and easily carried. However, since the headphone body of the in-ear type headphone device is inserted into the ear canal, the user may be suffered from foreign body sensation and poor wear comfort in the ear. Moreover, the headphone body of the in-ear type headphone device is prone to falling out from the ear and difficultly fixed in the ear. The circumaural type headphone device is worn on the head of the user, and the user's ear is surrounded by the headphone body of the circumaural type headphone device. The circumaural type headphone device is comfortable to the user. However, the circumaural type headphone device is lager and difficultly carried. Moreover, the circumaural type headphone device is not feasible to the user who wears glasses. If the glasses and the circumaural type headphone device are simultaneously worn, the glasses and the circumaural type headphone device may interfere with each other. Under this circumstance, it is difficult to wear the circumaural type headphone device or the glasses. Since different headphone devices have their features, the user may select a desired headphone device according to the practical requirements.

In recent years, the headphone device is equipped with plural buttons for facilitating the user to operate the headphone device. When the headphone device is worn by the user, the user may press one of the buttons to execute the “Previous”, “Next”, “Play” or “Pause” function. However, these buttons can be triggered to provide the above functions. That is, the functions cannot be extended.

Therefore, it is important to increase the controlling function of the headphone device.

### SUMMARY OF THE INVENTION

An object of the present invention provides a headphone device with a controlling function. Moreover, the functions of the headphone device are increased.

In accordance with an aspect of the present invention, there is provided a headphone device for receiving a sound signal from an audio generator and playing the sound signal. The headphone device includes a headphone body, a speaker and a transmitter. The headphone body is in contact with an ear of a user. The speaker is disposed within the headphone body. After the sound signal from the audio generator is received, the sound signal is outputted from the speaker. The transmitter is detachably fixed on the headphone body. The transmitter is in communication with the headphone body and the audio generator to receive the sound signal from the audio generator and transmit the sound signal to the speaker. The transmitter includes an optical finger navigation module. The optical finger navigation module is installed on the transmitter and exposed to an operating surface of the transmitter. When an operation on the optical finger navigation module with a finger of the user is detected by the optical finger navigation module, the optical finger navigation module generates a control signal, wherein the audio generator is controlled according to the control signal.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic perspective view illustrating the structure of a headphone device with a controlling function according to a first embodiment of the present invention;

FIG. 2 is a schematic perspective view illustrating the structure of the headphone device according to the first embodiment of the present invention and taken along another viewpoint;

FIG. 3 is a schematic functional block diagram illustrating the headphone device according to the first embodiment of the present invention;

FIG. 4 is a schematic side cross-sectional view of the optical finger navigation module of the headphone device according to the first embodiment of the present invention;

FIG. 5 is a schematic side view illustrating a portion of the headphone device according to the first embodiment of the present invention;

FIG. 6 is a schematic perspective view illustrating the structure of a headphone device with a controlling function according to a second embodiment of the present invention; and

FIG. 7 is a schematic functional block diagram illustrating the headphone device according to the second embodiment of the present invention.

### DETAILED DESCRIPTION OF THE PREFERRED EMBODIMENT

For obviating the drawbacks of the prior art technologies, the present invention provides a headphone device with a controlling function.

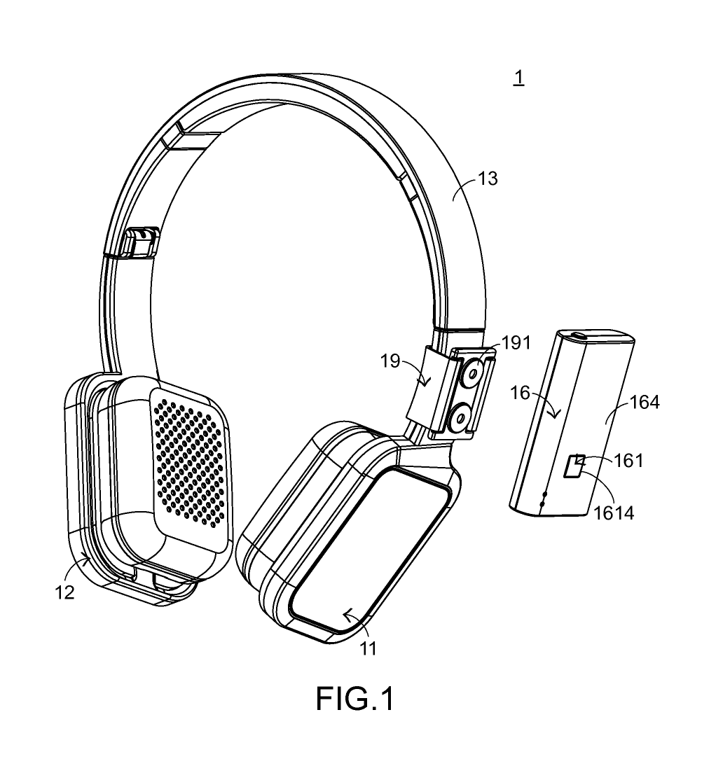

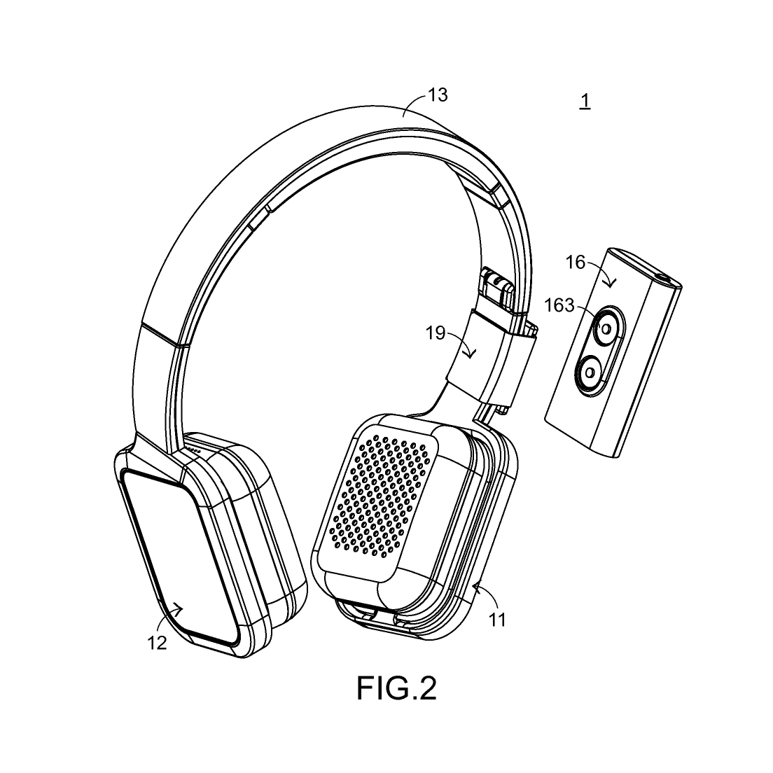

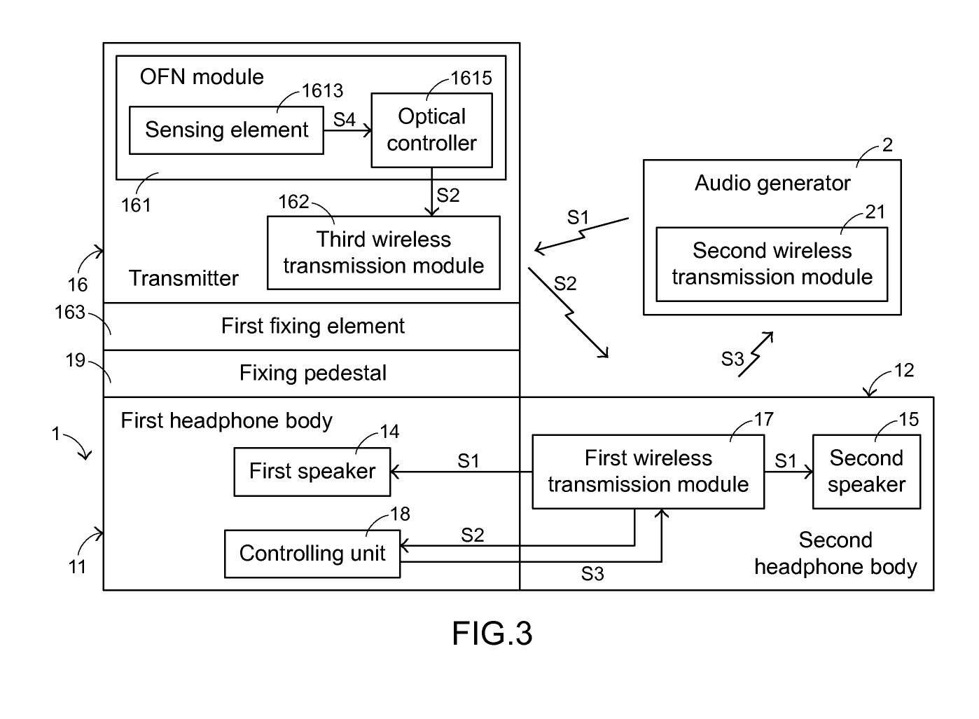

Hereinafter, the structure of the headphone device of the present invention will be illustrated with reference to FIGS. 1, 2 and 3. FIG. 1 is a schematic perspective view illustrating the structure of a headphone device with a controlling function according to a first embodiment of the present invention. FIG. 2 is a schematic perspective view illustrating the structure of the headphone device according to the first embodiment of the present invention and taken along another viewpoint. FIG. 3 is a schematic functional block diagram illustrating the headphone device according to the first embodiment of the present invention. The headphone device 1 is in communication with an audio generator 2. The audio generator 2 may generate a sound signal S1. The headphone device 1 is used for receiving and playing the sound signal S1. The headphone device 1 comprises a first headphone body 11, a second headphone body 12, a head band 13, a first speaker 14, a second speaker 15, a transmitter 16, a first wireless transmission module 17, a controlling unit 18 and a fixing pedestal 19. The first wireless transmission module 17 is disposed within the second headphone body 12. A second wireless transmission module 21 is disposed within the audio generator 2. The first wireless transmission module 17 may be in wireless communication with the second wireless transmission module 21 by a wireless transmission technology. In this embodiment, the headphone device 1 is a supra-aural headphone device, which is one kind of circumaural type headphone device. The audio generator 2 is a smart phone. Moreover, the first wireless transmission module 17 and the second wireless transmission module 21 are Wi-Fi transmission modules, which are in wireless communication with each other by a Wi-Fi transmission technology. It is noted that numerous modifications and alterations may be made while retaining the teachings of the invention. For example, in another embodiment, the first wireless transmission module and the second wireless transmission module are in wireless communication with each other by a 2.4G wireless transmission technology, a 5G wireless transmission technology or a 5.8G wireless transmission technology.

The first headphone body 11 and the second headphone body 12 correspond to a left ear and a right ear of the user, respectively. Moreover, the first headphone body 11 and the second headphone body 12 are connected with each other through the head band 13. When the headphone device 1 is worn by the user, the first headphone body 11 is in contact with the left ear of the user, and the second headphone body 12 is in contact with the right ear of the user. The first speaker 14 is disposed within the first headphone body 11 and connected with the first wireless transmission module 17. After the sound signal S1 from the audio generator 2 is received, the sound signal S1 may be outputted from the first speaker 14. Like the first speaker 14, the second speaker 15 is disposed within the second headphone body 12 and connected with the first wireless transmission module 17. After the sound signal S1 from the audio generator 2 is received, the sound signal S1 may be outputted from the second speaker 15. By means of the first speaker 14 and the second speaker 15, the both ears of the user wearing the headphone device 1 can hear the sound signal S1. The first speaker 14 is connected with the first wireless transmission module 17 through a signal wire (not shown). The signal wire is extended to the second headphone body 12 through the head band 13 so as to be connected with the first wireless transmission module 17.

As shown in FIGS. 1 and 2, the transmitter 16 is detachably fixed on the first headphone body 11. Moreover, the transmitter 16 is in communication with the second headphone body 12 and the audio generator 2. The transmitter 16 is used for receiving the sound signal S1 and transmits the sound signal S1 to the first speaker 14 and the second speaker 15. In this embodiment, the transmitter 16 comprises an optical finger navigation (OFN) module 161, a third wireless transmission module 162 and a first fixing element 163. The optical finger navigation module 161 is disposed on the transmitter 16 and exposed to an operating surface 164 of the transmitter 16. The optical finger navigation module 16 is used to detect the movement of the user's finger F, thereby generating a moving trajectory signal S2. The top surface of the optical finger navigation module 16 is not at the same level of the operating surface 164 of the transmitter 16.

The third wireless transmission module 162 is connected with the optical finger navigation module 161. The third wireless transmission module 162 may be in wireless communication with the first wireless transmission module 17 by a wireless transmission technology. Consequently, the wireless connection between the transmitter 16 and the second headphone body 12 is established. Moreover, the third wireless transmission module 162 may be in wireless communication with the second wireless transmission module 21, so that the wireless connection between the transmitter 16 and the audio generator 2 is established. The transmitter 16 may receive the sound signal S1 though the third wireless transmission module 162 and output the moving trajectory signal S2 and the sound signal S1 though the third wireless transmission module 162. The first fixing element 163 is disposed on a fixing surface 165 of the transmitter 165. When the first fixing element 163 is combined with the fixing pedestal 19, the transmitter 16 is fixed on the fixing pedestal 19. In this embodiment, the operating surface 164 of the transmitter 16 is an outer surface of the transmitter 16, and the third wireless transmission module 162 is also the Wi-Fi transmission module.

As shown in FIG. 3, the controlling unit 18 is disposed within the first headphone body 11, and connected with the first wireless transmission module 17. The controlling unit 18 is connected with the first wireless transmission module 17 through an additional signal wire (not shown). The additional wire is also extended to the second headphone body 12 through the head band 13 so as to be connected with the first wireless transmission module 17. Moreover, according to the moving trajectory signal S2 generated by the optical finger navigation module 161, the controlling unit 18 generates a corresponding control signal S3. The control signal S3 is transmitted from the controlling unit 18 to the audio generator 2 through the first wireless transmission module 17. The fixing pedestal 19 is disposed on the first headphone body 11, and comprises a second fixing element 191. When the second fixing element 191 and the first fixing element 163 are combined with each other, the transmitter 16 is fixed on the fixing pedestal 19. In this embodiment, the first fixing element 163 and the second fixing element 191 are magnetic elements. As long as the first fixing element 163 and the second fixing element 191 are detachably combined with each other, the types of the first fixing element 163 and the second fixing element 191 are not restricted.

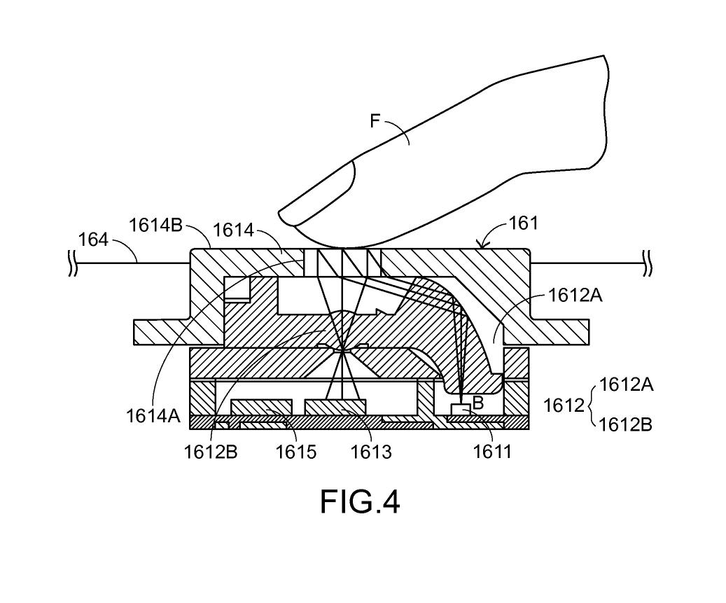

Hereinafter, the detailed structure of the optical finger navigation module 161 will be illustrated with reference to FIGS. 3 and 4. FIG. 4 is a schematic side cross-sectional view of the optical finger navigation module of the headphone device according to the first embodiment of the present invention. The optical finger navigation module 161 comprises a light source 1611, an optical assembly 1612, a sensing element 1613, an upper cover 1614 and an optical controller 1615. The light source 1611 emits a light beam B. The optical assembly 1612 is used for reflecting the light beam B to the user's finger F and focusing the light beam B which is reflected by the user's finger F. In this embodiment, the optical assembly 1612 comprises a reflective mirror 1621A and a focusing lens 1621B. The reflective mirror 1621A is located near the light source 1611 for reflecting the light beam B, so that the light beam B is projected to a transparent part 1614A of the upper cover 1614. The focusing lens 1612B is located near the sensing element 1613. After the light beam B is reflected by the user's finger F, the light beam B is focused by the focusing lens 1612B.

The sensing element 1613 is used for receiving the focused light beam B, thereby generating plural image signals S4. The optical controller 1615 is in communication with the sensing element 1613 and the controlling unit 18. After the plural image signals S4 are analyzed by the optical controller 1615, the corresponding moving trajectory signal S2 is generated by the optical controller 1615 and the moving trajectory signal S2 is transmitted to the controlling unit 18. The moving trajectory signal S2 contains a vector corresponding to the movement of the user's finger F. The method of analyzing the plural image signals S4 and generating the moving trajectory signal S2 containing the vector corresponding to the movement of the user's finger F is well known to those skilled in the art, and is not redundantly described herein. An example of the sensing element 1613 includes is not limited to a charge coupled device (CCD) or a complementary metal-oxide semiconductor (CMOS).

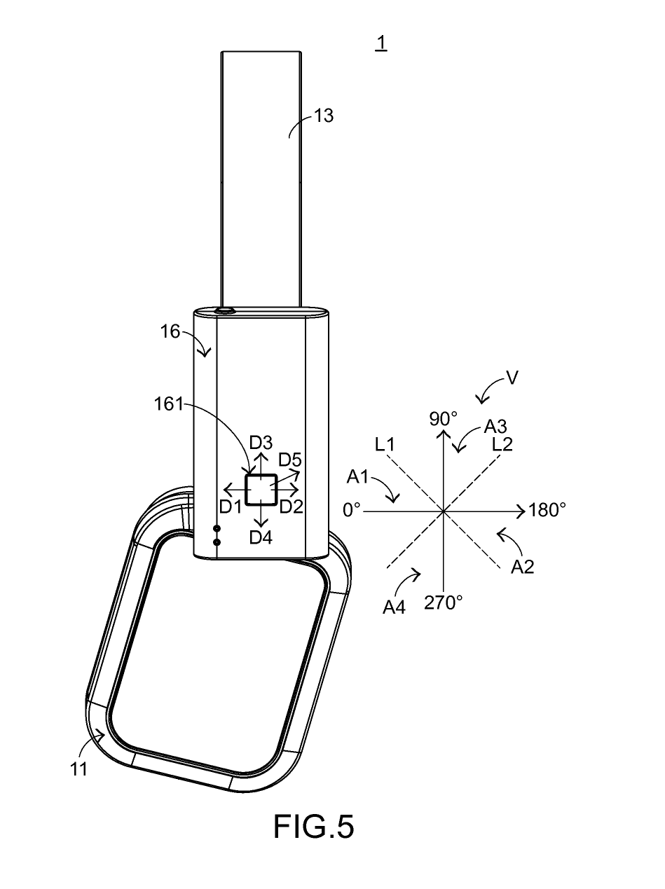

The principle of operating the optical finger navigation module 161 by the user will be illustrated as follows. FIG. 5 is a schematic side view illustrating a portion of the headphone device according to the first embodiment of the present invention. As shown in FIG. 5, the transmitter 16 is fixed on the fixing pedestal 19. When the headphone device 1 worn by the user and the user's finger F is moved on the optical finger navigation module 161, the movement of the user's finger F is detected by the optical finger navigation module 161. Consequently, the moving trajectory signal S2 corresponding to the movement of the user's finger F is outputted from the optical finger navigation module 161 and transmitted to the controlling unit 18. After the moving trajectory signal S2 is analyzed by the controlling unit 18, the corresponding control signal S3 is generated.

Moreover, plural function commands corresponding to plural control signals S3 have been previously stored in the controlling unit 18. For example, if the user's finger F is moved on the optical finger navigation module 161 in a first direction D1, the optical finger navigation module 161 generates the moving trajectory signal S2 corresponding to the movement in the first direction D1, and the controlling unit 18 generates the control signal S3 corresponding to the first direction D1. Moreover, according to the control signal S3 corresponding to the first direction D1, the function command corresponding to the function of playing the previous song is executed.

If the user's finger F is moved on the optical finger navigation module 161 in a second direction D2, the optical finger navigation module 161 generates the moving trajectory signal S2 corresponding to the movement in the second direction D2, and the controlling unit 18 generates the control signal S3 corresponding to the second direction D2. Moreover, according to the control signal S3 corresponding to the second direction D2, the function command corresponding to the function of playing the next song is executed.

If the user's finger F is moved on the optical finger navigation module 161 in a third direction D3, the optical finger navigation module 161 generates the moving trajectory signal S2 corresponding to the movement in the third direction D3, and the controlling unit 18 generates the control signal S3 corresponding to the third direction D3. Moreover, according to the control signal S3 corresponding to the third direction D3, the function command corresponding to the function of increasing the sound volume is executed.

If the user's finger F is moved on the optical finger navigation module 161 in a fourth direction D4, the optical finger navigation module 161 generates the moving trajectory signal S2 corresponding to the movement in the fourth direction D4, and the controlling unit 18 generates the control signal S3 corresponding to the fourth direction D4. Moreover, according to the control signal S3 corresponding to the fourth direction D4, the function command corresponding to the function of decreasing the sound volume is executed.

In addition to the above four function commands corresponding to the four moving directions, the following function commands may be previously stored in the controlling unit 18. Firstly, if the user's finger F continuously presses a position of the optical finger navigation module 161 for a specified time period (e.g. 2 seconds), the optical finger navigation module 161 generates the moving trajectory signal S2 corresponding to the non-movement, and the controlling unit 18 generates the corresponding control signal S3. Consequently, the function command corresponding to the function of allowing the audio generator 2 to answer a call is executed. Secondly, if the user's finger F continuously taps the optical finger navigation module 161 twice in a specified time period (e.g. 1 second), the optical finger navigation module 161 generates the moving trajectory signal S2 corresponding to the continuous tapping action, and the controlling unit 18 generates the corresponding control signal S3. Consequently, the function command corresponding to the function of allowing the audio generator 2 to play or pause is executed.

However, even if the user's finger F is accurately moved in the first direction D1, there is possibly an error angle between the moving trajectory of the user's finger F and the first direction D1. Consequently, an operating range corresponding to the first direction D1 is set in the controlling unit 18. That is, the trajectory within the operating range is considered as the movement in the first direction D1 by the controlling unit 18. In accordance with the present invention, the controlling unit 18 defines a vector coordinate system V, and the controlling unit 18 recognizes the moving direction corresponding to the moving trajectory of the user's finger F according to the vector coordinate system V. An example of the vector coordinate system V is shown in FIG. 5. The vector coordinate system V is divided into a first direction zone A1, a second direction zone A2, a third direction zone A3 and a fourth direction zone A4 by two diagonal lines L1 and L2. The first direction zone A1 covers the angle range between a first angle and a second angle, and the first direction zone A1 corresponds to the first direction D1. The second direction zone A2 covers the angle range between a third angle and a fourth angle, and the second direction zone A2 corresponds to the second direction D2. The third direction zone A3 covers the angle range between a fifth angle and a sixth angle, and the third direction zone A3 corresponds to the third direction D3. The fourth direction zone A4 covers the angle range between a seventh angle and an eighth angle, and the fourth direction zone A4 corresponds to the fourth direction D4.

In this embodiment, the first angle is 316°, and the second angle is 44°. Consequently, the first direction zone A1 covers the angle range between 316° and 44°. Moreover, the third angle is 136°, and the second angle is 224°. Consequently, the second direction zone A2 covers the angle range between 136° and 224°. Moreover, the fifth angle is 46°, and the sixth angle is 134°. Consequently, the third direction zone A3 covers the angle range between 46° and 134°. Moreover, the seventh angle is 226°, and the eighth angle is 314°. Consequently, the fourth direction zone A4 covers the angle range between 226° and 314°.

Hereinafter, the operating principle of moving the user's finger on the optical finger navigation module 161 will be illustrated with reference to FIG. 3 and FIG. 5. For example, if the user's finger F is moved on the optical finger navigation module 161 in a fifth direction D5, the optical finger navigation module 161 generates the moving trajectory signal S2 corresponding to the movement in the fifth direction D5. Since the fifth direction D5 is not identical to any of the first direction D1, the second direction D2, the third direction D3 and the fourth direction D4, the controlling unit 18 then calculates the vector of the fifth direction D5. For example, if the vector of the fifth direction D5 obtained by the controlling unit 18 is 150°, the controlling unit 18 realizes that the vector of the fifth direction D5 is correlated with the second direction zone A2 according to the vector coordinate system V. Consequently, the controlling unit 18 generates the control signal S3 corresponding to the second direction D2. The control signal S3 is transmitted to the audio generator 2 through the first wireless transmission module 17. According to the control signal S3, the function command corresponding to the function of playing the next song is executed.

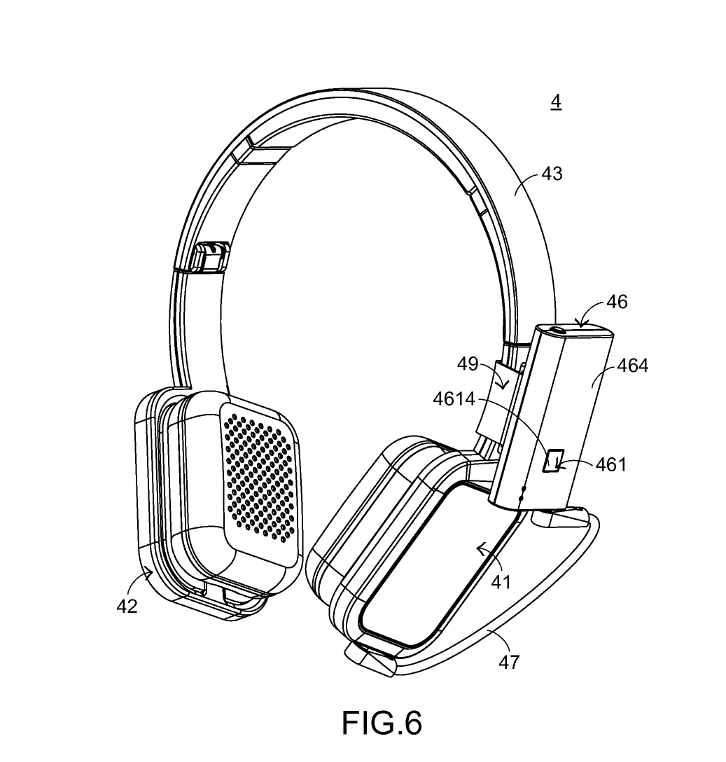

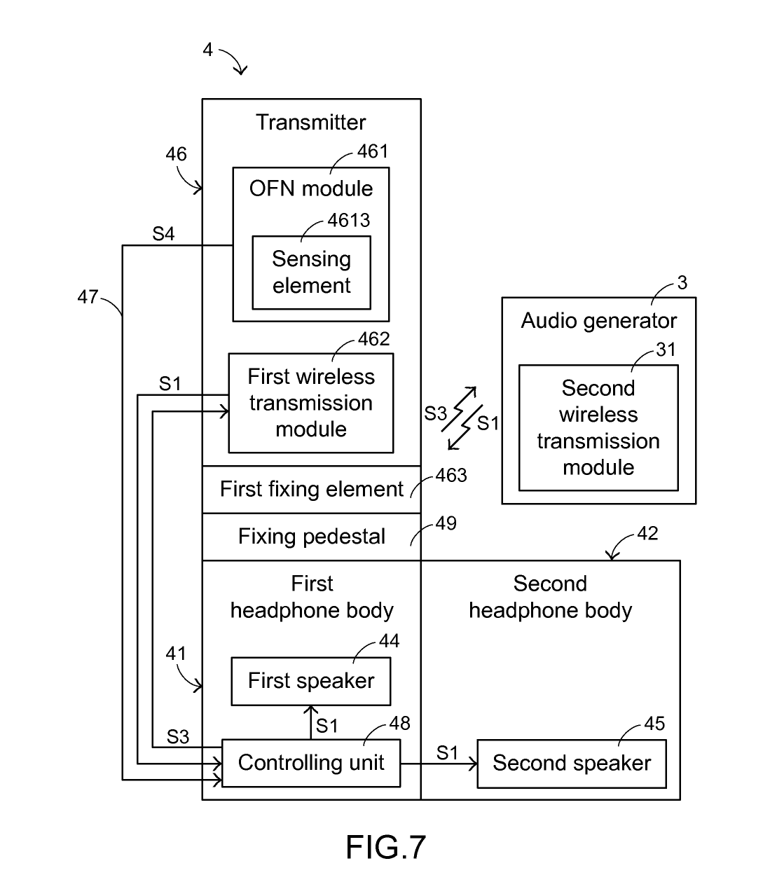

The present invention further provides a second embodiment, which is distinguished from the first embodiment. Please refer to FIGS. 6 and 7. FIG. 6 is a schematic perspective view illustrating the structure of a headphone device with a controlling function according to a second embodiment of the present invention. FIG. 7 is a schematic functional block diagram illustrating the headphone device according to the second embodiment of the present invention. The headphone device 4 is in communication with an audio generator 3. The audio generator 3 may generate a sound signal S1. The headphone device 4 is used for receiving and playing the sound signal S1. The headphone device 4 comprises a first headphone body 41, a second headphone body 42, a head band 43, a first speaker 44, a second speaker 45, a transmitter 46, a connecting wire 47, a controlling unit 48 and a fixing pedestal 49. In this embodiment, the transmitter 46 comprises an optical finger navigation module 461, a first wireless transmission module 462 and a first fixing element 463. Except for the following two items, the functions and the structures of other components of the headphone device 4 are identical to those of the first embodiment, and are not redundantly described herein.

Firstly, the connecting wire 47 of the headphone device 4 is plugged into the transmitter 46, so that the wired connection between the headphone device 4 and the transmitter 46 is established. Moreover, the first wireless transmission module 462 is in wireless communication with a second wireless transmission module 31 of the audio generator 3, so that the wireless connection between the transmitter 46 and the audio generator 3 is established. Consequently, after the connecting wire 47 of the headphone device 4 is plugged into the transmitter 46, the headphone device 4 has the wireless transmission function. For example, after the audio signal S1 is outputted from the audio generator 3 by the wireless transmission technology, the audio signal S1 is received by the transmitter 46 and then the audio signal S1 is transmitted to the first speaker 44 and the second speaker 45 through the connecting wire 47.

Secondly, the optical finger navigation module 461 only comprises a light source, an optical assembly, a sensing element 4613 and an upper cover 4614. That is, the optical finger navigation module 461 does not comprise an optical controller. As shown in FIG. 7, the sensing element 4613 of the optical finger navigation module 461 is connected with the controlling unit 48. After the plural image signals S4 from the sensing element 4613 are analyzed by the controlling unit 48, the corresponding moving trajectory signal is obtained and the corresponding control signal S3 is generated by the controlling unit 48. In other words, the computing tasks of the controlling unit 18 and the optical controller 165 of the first embodiment are implemented by the controlling unit 48 of the headphone device 4 of this embodiment.

The following two aspects should be specially described. Firstly, in this embodiment, the optical finger navigation module 461 is installed on an operating surface 464 of the transmitter 46, and the operating surface 464 is the outer surface of the transmitter 46. It is noted that the position of the operating surface is not restricted. Alternatively, in another embodiment, the operating surface is a lateral side surface of the transmitter 46. That is, the optical finger navigation module is installed on the lateral side surface of the transmitter 46.

Secondly, when the headphone device 4 is worn by the user, it is desirable to facilitate the user to recognize the position of the optical finger navigation module 461 without the need of watching the optical finger navigation module 461. In a design, the altitude of the top surface of the optical finger navigation module 461 is different from (e.g. higher than) the altitude of the operating surface of the transmitter 46. Consequently, when the headphone device 4 is worn by the user and the user's finger F is in contact with the raised optical finger navigation module 461, the user can recognize the position of the optical finger navigation module 461. Under this circumstance, the user can operate the optical finger navigation module 461 without the need of watching the optical finger navigation module 461 with the user's eyes.

Moreover, the headphone device may have other designs so as to achieve the above benefits. For example, the altitude of the top surface of the optical finger navigation module is lower than the altitude of the operating surface of the transmitter. Alternatively, a salient higher than the operating surface of the transmitter is formed on the optical finger navigation module. Alternatively, a recess lower than the operating surface of the transmitter is formed in the surface of the optical finger navigation module. In other words, since the altitude of the optical finger navigation module and the altitude of the operating surface of the transmitter are different from each other, the user can easily recognize the position of the optical finger navigation module. It is noted that the relationship between the altitude of the optical finger navigation module and the altitude of the operating surface of the transmitter is not restricted. For example, in some other embodiments, the altitude of the optical finger navigation module and the altitude of the operating surface of the transmitter are identical to each other.

From the above descriptions, the present invention provides a headphone device with a controlling function. A transmitter is fixed on a headphone body. An optical finger navigation module is installed on the transmitter for allowing the user to perform the control function. After the optical finger navigation module detects the movement of the finger or the tapping action of the finger, plural image signals are correspondingly generated. Consequently, even if the user wears a glove on a hand, the optical finger navigation module can be normally operated by the user without causing erroneous operation. Moreover, in case that the headphone device is a wired headphone device, the headphone device may be connected with the transmitter through a connecting wire in order to achieve the wireless transmission function. Since the connecting wire is arranged between the headphone device and the transmitter, the headphone device can be in wireless communication with an audio generator through a wireless transmission module of the transmitter. Under this circumstance, the headphone device may be considered as a wireless headphone device. Moreover, the optical finger navigation module is cost-effective, and the installation of the optical finger navigation module is simple. That is, the altitude of the optical finger navigation module is different from the altitude of the operating surface of the transmitter, or an upper cover of the optical finger navigation module has an identification salient or an identification recess.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A headphone device for receiving a sound signal from an audio generator and playing the sound signal, the headphone device comprising:
a headphone body in contact with an ear of a user;
a speaker disposed within the headphone body, wherein after the sound signal from the audio generator is received, the sound signal is outputted from the speaker; and
a transmitter detachably fixed on the headphone body, wherein the transmitter is in communication with the headphone body and the audio generator to receive the sound signal from the audio generator and transmit the sound signal to the speaker, wherein the transmitter comprises an optical finger navigation module, and the optical finger navigation module is installed on the transmitter and exposed to an operating surface of the transmitter, wherein when an operation on the optical finger navigation module with a finger of the user is detected by the optical finger navigation module, the optical finger navigation module generates a control signal, wherein the audio generator is controlled according to the control signal.

2. The headphone device according to claim 1, wherein the optical finger navigation module comprises:
a light source emitting a light beam to the finger;
an optical assembly reflecting the light beam to the finger and focusing the light beam which is reflected by the finger;
a sensing element receiving the focused light beam, and generating plural image signals according to the focused light beam; and
an upper cover sheltering the optical assembly, wherein the upper cover has a transparent part, and the light beam is transmissible through the transparent part.

3. The headphone device according to claim 2, wherein the optical assembly comprises:
a reflective mirror located near the light source, wherein when the light beam is reflected by the reflective mirror, the light beam is projected to the transparent part of the upper cover; and
a focusing lens located near the sensing element, wherein after the light beam is reflected by the finger, the light beam is focused by the focusing lens.

4. The headphone device according to claim 1, wherein the operating surface of the transmitter is an outer surface or a lateral side surface of the transmitter.

5. The headphone device according to claim 2, further comprising:
a wireless transmission module disposed within the transmitter, wherein when a wireless connection between the headphone device and the audio generator is established through the wireless transmission module by a wireless transmission technology, the sound signal and the control signal are transmitted between the headphone device and the audio generator; and
a controlling unit disposed within the headphone body, and in communication with the optical finger navigation module and the wireless transmission module, wherein the controlling unit generates the corresponding control signal according to the plural image signals generated by the optical finger navigation module, and the control signal is transmitted from the controlling unit to the audio generator through the wireless transmission module.

6. The headphone device according to claim 5, wherein after the plural image signals are received by the controlling unit, the plural image signals are analyzed by the controlling unit, so that a moving trajectory signal is generated, wherein the controlling unit generates the corresponding control signal according to the moving trajectory signal, wherein the controlling unit defines a vector coordinate system, wherein the vector coordinate system is divided into a first direction zone, a second direction zone, a third direction zone and a fourth direction zone.

7. The headphone device according to claim 6, wherein if a vector corresponding to the moving trajectory signal lies in the first direction zone, the control signal corresponding to the first direction zone is generated by the controlling unit, wherein if the vector corresponding to the moving trajectory signal lies in the second direction zone, the control signal corresponding to the second direction zone is generated by the controlling unit, wherein if the vector corresponding to the moving trajectory signal lies in the third direction zone, the control signal corresponding to the third direction zone is generated by the controlling unit, wherein if the vector corresponding to the moving trajectory signal lies in the fourth direction zone, the control signal corresponding to the fourth direction zone is generated by the controlling unit.

8. The headphone device according to claim 1, wherein the headphone body and the transmitter are connected with each other through a connecting wire, so that the transmitter and the headphone body are in communication with each other.
